(19) United States
(12) Patent Application Publication
(10) Pub. No.: US 2010/0171812 A1
(43) Pub. Date: Jul. 8, 2010

(54) FORMAT FOR ENCODED STEREOSCOPIC IMAGE DATA FILE

(76) Inventors: Kyu Heon Kim, Seoul (KR); Yoon Jin Lee, Gyeonggi-do (KR); Gwang Hoon Park, Gyeonggi-do (KR); Doug Young Suh, Gyeonggi-do (KR); Sung Moon Chun, Gyeonggi-do (KR); Yong Hyub Oh, Seoul (KR); Tae Sup Jung, Seoul (KR); Dae Seob Byun, Seoul (KR)

Correspondence Address: North Star Intellectual Property Law, PC, P.O. Box 34688, Washington, DC, 20043, US

(21) Appl. No.: 12/663,008

(22) PCT Filed: Jun. 5, 2008
(86) PCT No.: PCT/KR2008/003145

§ 371 Date: Dec. 4, 2009

(30) Foreign Application Priority Data
Jun. 7, 2007 (KR) 10-2007-0055620
Jul. 26, 2007 (KR) 10-2007-0075212

(51) Int. Cl. H04N 13/00

(52) U.S. Cl. 348/43; 348/E13.06

(57) ABSTRACT

A method of constructing an encoded stereoscopic image data file is provided. The encoded stereoscopic image data file includes a file type declaration unit indicating whether the file is a stereoscopic image, a meta data unit including one or more track containers for containing meta data of the encoded stereoscopic image data, and an image data unit including one or more stereoscopic image data containers for containing image information of the encoded stereoscopic image data.

### TECHNICAL FIELD

The present invention relates to a data file format, and more particularly, to a file format for storing or transmitting encoded stereoscopic image data or a method of constructing a file for storing or transmitting encoded stereoscopic image data.

### BACKGROUND ART

A binocular stereoscopic image (hereinafter, referred to as ‘a stereoscopic image’) denotes a pair of left and right images obtained by photographing a subject by using separate left and right cameras. Although the left and right images are obtained by photographing the same subject, viewpoints are different. Thus, image information may be different according to a surface feature of the subject, a position of a light source, and the like. A difference in image information between the left and right images of the subject is referred to as disparity.

The stereoscopic image generally indicates images taken by using the left and right cameras. In a broad sense, the stereoscopic image includes a three-dimensional image generated by applying a predetermined transformation algorithm to a monoscopic image. The stereoscopic image may be generally used to add a three-dimensional effect to the displayed subject.

There are various methods of adding the three dimensional effect to an image reproduced through a flat display device such as a liquid crystal display (LCD) and a plasma display panel (PDP) by using a stereoscopic image. In one of these methods, a barrier type display device may be used. Since the barrier type display device can display both of monoscopic and stereoscopic images, the barrier type display device is spotlighted as one of next generation display devices.

In the barrier type display device, a barrier polarizing plate is attached to or included in a front surface of the flat display device. The barrier polarizing plate includes line-type barrier patterns. Only left parts of the displayed image are viewed by a left eye through the barrier patterns. Only right parts of the displayed images are viewed by a right eye through the barrier patterns. There are various types of barrier patterns. Basically, there are vertical and horizontal line types. Then, the barrier patterns are classified into a bar type, a saw-tooth type, and an oblique line type. These types of the barrier patterns cause difference in three-dimensional effect of the displayed image.

On the other hand, monoscopic image data on still images or moving pictures (images will include both of still images and moving pictures throughout the specification), which are encoded according to an existing encoding standard, are largely classified into two types and stored. One is image information that is directly related to pixel values of the images. The other is meta data that is additional information needed for decoding and displaying the image information. Although the image information may be different according to types of international standards for encoding images, the image information may include texture information such as luminance and chrominance, and motion information. In addition, the image information may further include shape information of backgrounds and objects. The meta data includes additional data needed for reproducing and displaying the image information, in addition to the image information.

The image information may be arbitrarily distinguished from the meta data. The distinction may depend on contents of the international standards or classification standards of data. In this specification, ‘image data’ generally indicates both of the image information and the meta data. In some cases, the image data may indicate only the image data. The meanings of the image data included in parts of the specification have to be analyzed according to the context, respectively. For example, ‘image data’ in an image data unit of FIG. 1 simply indicates image information. However, image data in the title of the present invention indicates both of image data and meta data.

FIG. 1 is a block diagram illustrating an existing file format for storing encoded monoscopic image data. Referring to FIG. 1, an existing file format 10 includes a basic header unit 12 and an image data unit 14. The image data unit 14 includes image information of encoded image data such as texture information, shape information, and/or motion information. The basic header unit 12 includes additional data except the image information included in the image data unit 14. However, an existing file format 10 of image data is suitable to store and/or transmit encoded monoscopic image data, but the existing file format 10 is not suitable to store and/or transmit encoded stereoscopic image data. Unlike the monoscopic image, the stereoscopic image obtains a pair of left and right images by using left and right cameras and encodes the stereoscopic image by combining the obtained pair of left and right images in various manners. In addition, a specific display device such as a barrier type display is used to reproduce the stereoscopic images.

### DISCLOSURE OF INVENTION

### Technical Problem

Since a stereoscopic image consists of a pair of left and right images unlike an existing monoscopic image, a frame to be encoded may be constructed in various manners. For example, a frame to be encoded may be constructed by combining a pair of left and right images. There are various methods of combining the left and right images. There are various methods of setting two or more frames to be encoded through the pair of left and right images. Since there are various methods of constructing a frame to be encoded by using a pair of left and right images, there are various values, types, and features of the image data and the meta data generated by encoding the image. However, the aforementioned file format is not suitable to systematically construct and store various types of information and derivative data.

Accordingly, the present invention provides a method of constructing a file format or a file capable of effectively and systematically storing encoded stereoscopic image data.

The encoded stereoscopic image data is obtained by encoding the image obtained by using a pair of separate left and right cameras. Features of the left and right cameras, for example, a distance between the left and right cameras and a difference in frame rate have an effect on image quality of a reproduced three-dimensional image or a three-dimensional effect. In addition, the encoded stereoscopic image data may be reproduced by using a specifically designed display device or displayed in various manners. Features of the display device or a displaying method have an effect on image quality of a three dimensional image or a three-dimensional effect. Thus, in order to reproduce a three-dimensional image optimized for a display device, information on a photographing camera and/or display device and information on a displaying method have to be included in the image data of the encoded stereoscopic image data. It is difficult to satisfy this request by using the existing file format.

Accordingly, the present invention also provides a method of constructing a file format or a file of encoded stereoscopic image data capable of displaying a vivid three-dimensional image by reflecting features of a photographing camera and/or a display device or a displaying method.

On the other hand, in the moving picture experts group (MPEG) which establishes international standards on multimedia, an international standardization organization (ISO) base media file format is defined. The ISO base media file format that is disclosed in part 12 of the joint photographic experts group (JPEG) 2000 and the ISO/IEC 15444-12 provides a basic file format for a future application. In addition, in the MPEG, a multimedia application file format (MAF) suitable for a purpose of a corresponding application is defined. In a case where the MAF is compatible with the ISO base media file format, various services using stereoscopic images are available.

Accordingly, the present invention also provides a method of constructing an encoded stereoscopic image data file compatible with an ISO base media file format and a format thereof.

### Technical Solution

According to an aspect of the present invention, there is provided a format of an encoded stereoscopic image data file, the format comprising: a file type declaration unit indicating whether the file is a stereoscopic image; a meta data unit including one or more track containers for containing meta data of the encoded stereoscopic image data; and an image data unit including one or more stereoscopic image data containers for containing image information of the encoded stereoscopic image data.

In the above aspect of the present invention, the file type declaration unit may include first information for indicating whether the file is related to a stereoscopic image and second information for indicating the number of elementary streams (ESs) which constitute the file. In this case, the number of the track containers and the number of the stereoscopic image data containers may be the same as the second information.

In addition, the track container may include a handler reference container for indicating a type of a corresponding ES and a media information container for containing meta data of the corresponding ES.

In this case, the media information container may include a stereoscopic header container containing information for indicating a size of a frame to be encoded. In addition, the stereoscopic header container may include a container for containing information for indicating a distance between left and right cameras used to obtain the stereoscopic image and/or a container for containing information for indicating a distance of a barrier pattern of a barrier type display device used to display the stereoscopic image and/or information for indicating an interval of the barrier pattern.

In addition, the media information container may include a sample description container for defining description of the corresponding ES. In this case, the sample description container may include ES type information for indicating a method of constructing a frame to be encoded.

For example, in a case where the second information of the file type declaration unit indicates that the number of ESs is one, the frame to be encoded which is indicated by the ES type information may have one of first to fifth types. In the first type, the left and right images are alternately arranged in units of frame in the direction of time axis. In the second type, the left and right images are arranged side by side. In the third type, the left and right images are arranged in a top-down manner. In the fourth type, vertical pixel lines of the left and right images are alternately arranged. In the fifth type, horizontal pixel lines of the left and right images are alternately arranged. In this case, the ES type information may indicate one of the second to fifth types, and the sample description container may further include information on frame rates of the left and right images which constitute the frame to be encoded and/or disparity information.

Here, the information on the frame rate may include information on whether a frame rate of the left image is the same as that of the right image and information for matching the frame rates of the left and right images with each other when displaying the stereoscopic image in a case where the frame rates of the left and right images are different from each other. The disparity information may include information on whether there is disparity between the left and right images and information for modifying the disparity in a case where there is disparity between the left and right images.

In addition, in a case where the second information of the file type declaration unit indicates that the number of ESs is two, the frame to be encoded which is indicated by the ES type information may be one of a left image, a right image, a reference image, and a differential image.

### Advantageous Effects

As described later, since the file format according to an embodiment of the present invention has a hierarchical structure and a structure for systematically storing unique meta data of a stereoscopic image, it is possible to efficiently construct and store encoded stereoscopic image data. In addition, since the file format according to an embodiment of the present invention has a structure for including information on features of a photographing camera and/or a display device for obtaining a stereoscopic image, it is possible to display a vivid three-dimensional image by using stored and encoded stereoscopic image data. In addition, a file format for storing encoded stereoscopic image data according to an embodiment of the present invention is compatible with an ISO base media file format that is an international standard.

### BRIEF DESCRIPTION OF THE DRAWINGS

FIG. 1 is a block diagram illustrating an existing file format for storing encoded monoscopic image data.

FIG. 2 illustrate a structure of an overall composite image in which left and right images are arranged side by side as a frame to be encoded.

FIG. 3 illustrates a structure of an overall composite image in which pixel lines of left and right images are alternately arranged as a frame to be encoded.

FIG. 4 illustrates a structure of an overall composite image in which left and right images are sequentially arranged in units of frame as a frame to be encoded.

FIG. 5 illustrates a structure of a frame to be encoded which consists of left and right images.

FIG. 6 illustrates a structure of a frame to be encoded which consists of a reference image and a differential image.

FIG. 7 illustrates a structure of a frame to be encoded which consists of a reference frame and a plurality of differential images.

FIG. 8 is a block diagram illustrating a file format for storing encoded stereoscopic image data according an embodiment of the present invention.

FIG. 9 is a block diagram illustrating a structure of a stereoscopic track container of FIG. 8.

FIG. 10 illustrates a hierarchical structure of a file format shown in FIGS. 8 and 9.

FIG. 11 illustrates an example of a syntax of an ssty box of FIG. 8.

FIG. 12 illustrates an example of a syntax of an hdlr box of FIG. 9.

FIG. 13 illustrates an example of a syntax of a stereoscopic header box of FIG. 9.

FIG. 14 illustrates an example of a syntax of a stereoscopic camera information box of FIG. 9.

FIG. 15 illustrates an example of a syntax of a stereoscopic display information box of FIG. 9.

FIGS. 16 to 19 illustrate examples of a syntax of an mpss box.

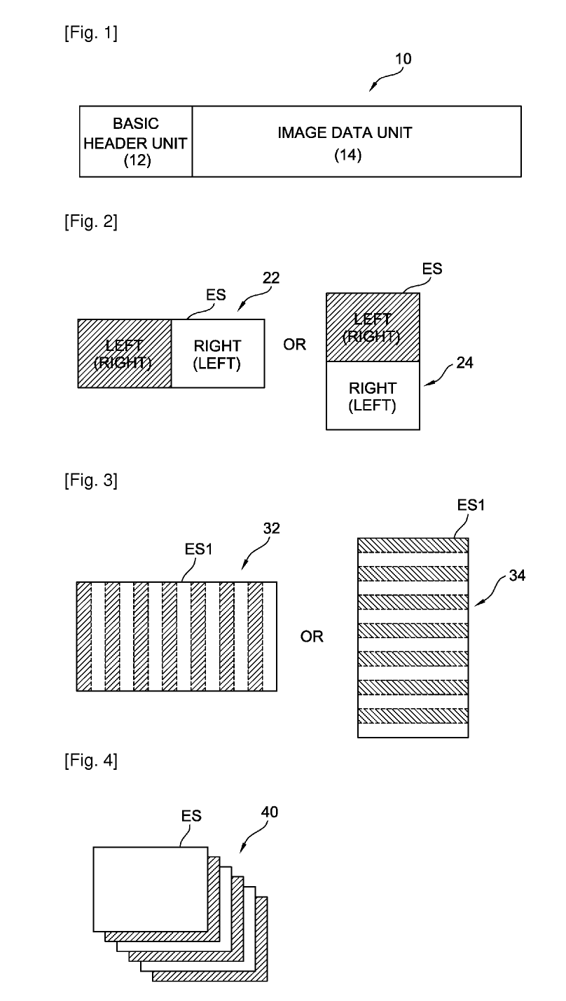

### BEST MODE FOR CARRYING OUT THE INVENTION

Hereinafter, exemplary embodiments of the present invention will be described in detail with reference to the accompanying drawings. The following embodiments should be considered in descriptive sense only and not for purpose of limitation. While the embodiments of the present invention are described by using specific terms, such description is for illustrative purpose only, and it is to be understood that changes and variations may be made without departing from the spirit of the present invention. Similarly, while the present invention is particularly shown and described with reference to the attached drawings, it will be understood by those skilled in the art that various changes in form and details may be made therein without departing from the spirit and scope of the invention.

Before describing embodiments of the present invention, considerations for defining a format of an encoded stereoscopic image data file according to an embodiment of the present invention will be described. The considerations are unique features of a stereoscopic image distinguished from those a monoscopic image.

The first consideration relates to a method of constructing a frame to be encoded by using left and right images. The method of constructing a frame to be encoded has a direct effect on a structure of encoded stereoscopic image data. For example, the number of elementary streams (ESs) which constitute the encoded image data depends on the method of constructing a frame to be encoded. Even in case of the same number of ESs, there may be various methods of constructing a frame to be encoded.

First, a frame to be encoded may be generated by using left and right images. Hereinafter, the frame generated by using the left and right images is referred to as an ‘integrated composite image’ or ‘composite image’. The stereoscopic image data generated by encoding the integrated composite image is constructed with an ES. There are various methods of constructing an integrated composite image by using a pair of left and right images. FIGS. 2 to 4 show examples of the method of constructing an integrated composite image.

In a method of constructing an integrated composite image, left and right images are arranged side by side. FIG. 2 illustrates this method. Referring to FIG. 2, in a frame to be encoded such as an integrated composite image 22, left and right images are arranged side by side. Alternatively, in a frame to be encoded such as an integrated composite image 24, left and right images are arranged in a top-down manner. In this case, positions of the left and right images which constitute the integrated composite image 22 or 24 may be exchanged with each other.

In another method of constructing an integrated composite image, left and right images are interleaved in units of field. FIG. 3 illustrates this arrangement. Referring to FIG. 3, an integrated composite image 32 may be a frame in which vertical pixel lines of the left image and vertical pixel lines of the right image are alternately arranged or a frame in which horizontal pixel lines of the left image and horizontal pixel lines of the right image are alternately arranged. Positions of pixel lines of the left and right images which constitute the integrated composite image 32 or 34 may be exchanged with each other.

In still another method of constructing an integrated composite image, left and right images are sequentially arranged in units of frame. FIG. 4 illustrates this arrangement. Referring to FIG. 4, an integrated composite image 40 is constructed by alternately arranging left and right images in units of frame in the direction of time axis. In case of this integrated composite image 40, pixels of the left image and pixels of the right image do not coexist in a frame to be encoded.

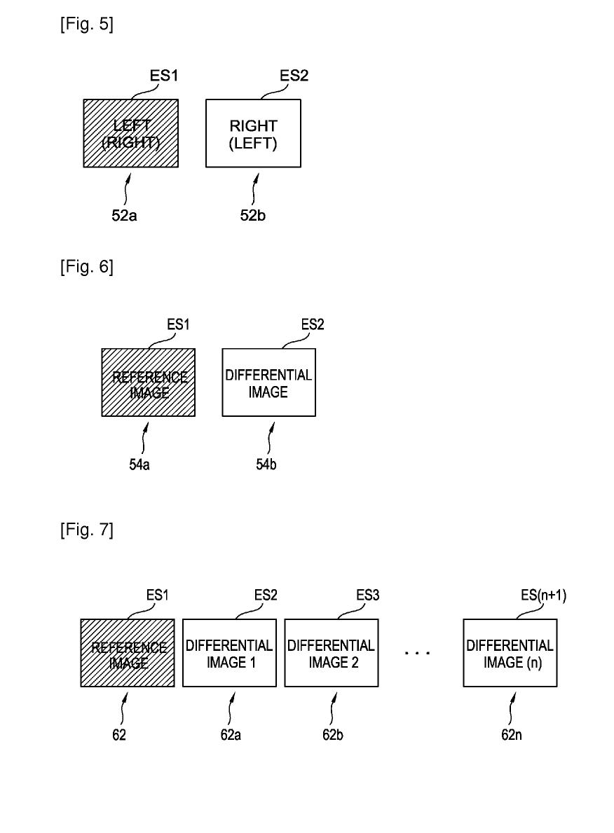

Next, referring to FIGS. 5 and 6, a case where two frames to be encoded are generated by using a pair of left and right images will be described. In case of two frames to be encoded, image data generated by encoding the two frames are constructed with two ESs.

Referring to FIG. 5, left and right images 52a and 52b are frames to be encoded, as they are. Then, when the frames 52a and 52b are encoded, the encoded image data are constructed with two elementary streams ES 1 and ES2 which represent respective images. On the other hand, referring to FIG. 6, a frame to be encoded may be constructed with a reference image 54a and a differential image 54b. In this case, one of left and right images is a frame to be encoded as the reference image 54a. The differential image 54b that is constructed with a differential (difference) from the reference image is the other frame to be encoded.

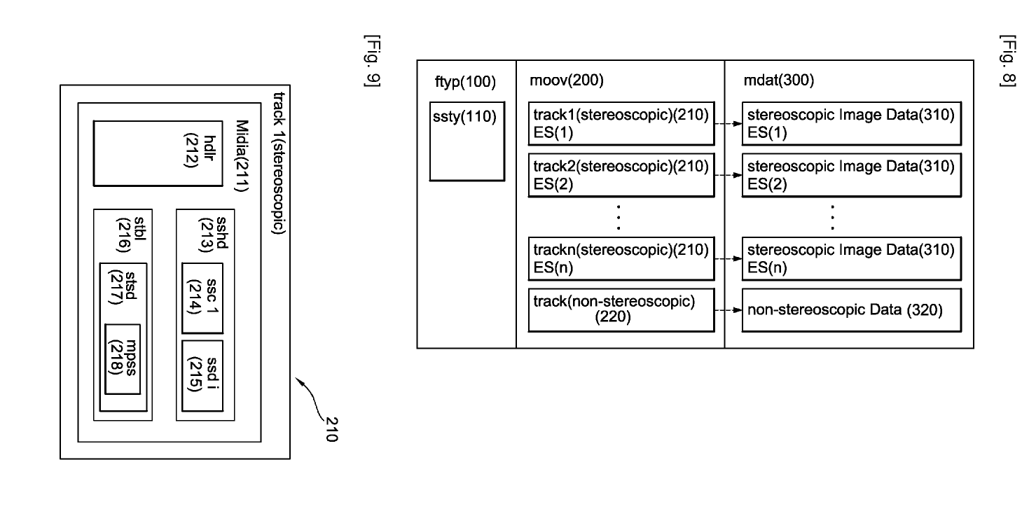

FIG. 7 illustrates a case where there are three frames to be encoded. Referring to FIG. 7, one of left and right images of sequential (n+1)/2 numbers of frames is a frame to be encoded as a reference image 62. The other images except the reference image are frames to be encoded as differential images 62a to 62n. When the frames to be encoded are encoded, the encoded image data are constructed with the (n+1) numbers of elementary streams ES1 to ES(n+1).

The aforementioned one or more frames to be encoded or a frame sequence to be encoded may be encoded by using an existing method of encoding an image. The existing method of encoding an image includes a method of encoding a still image such as a JPEG or a method of encoding a moving picture such as an MPEG-1, an MPEG-2, an MPEG-4, an H.264/AVC, a VC-1, and the like. Then, the image data encoded by using the existing method of encoding an image may be directly transmitted to a display device that supports the encoding method and reproduced. Alternatively, the image data may be stored in a storage medium and reproduced by a display device.

As described above, in case of a stereoscopic image, there are various methods of constructing a frame to be encoded. Then, the encoded stereoscopic image data may be constructed with two or more ESs. Even in case of the same number of ESs, there are various methods of constructing a frame to be encoded. Accordingly, derivative data or data needed for reproducing the image data may be changeable. A file format for storing the encoded stereoscopic image data has to be suitable to store a method of constructing a frame to be encoded and derivative data of the method.

The second consideration for defining a file format for storing the encoded stereoscopic image data is to use left and right cameras which are separated from each other at a predetermined interval so as to obtain a stereoscopic image. This is because information on the left and right cameras has to be provided to a display device so as to efficiently reproduce and/or improve image quality of a reproduced three-dimensional image or a three-dimensional effect. Accordingly, the encoded stereoscopic image data may additionally include the information on the left and right cameras. The file format for storing the encoded stereoscopic image data has to be defined in consideration of the additionally included information on the left and right cameras.

There are various types of information on the left and right cameras. For example, the various types of information includes information on a distance between the left and right cameras, the number of frames of the left and right images per second (frame/sec, fps) which are captured by using the left and right cameras, that is, a frame rate, information on synchronization of the left and right images, and/or information on types of the left and right cameras. In addition, in some cases, the various types of information may include disparity information between the left and right images.

The third consideration for defining a file format for storing the encoded stereoscopic image data is to use a specific display device different from the existing display device so as to reproduce a stereoscopic image (for example, a barrier type display device). This is because reproduced image data has to be suitable for the display device so as to reproduce a three-dimensional image by using the specific display device. In addition, since information on features of the display device may have an effect on image quality of the three-dimensional image or a three-dimensional effect, this information or additionally needed information has to be considered so as to define a format of the encoded stereoscopic image data file.

There are various types of information on the display device. For example, in a case where a reproduction device is a barrier type display device, the various types of information includes information on a barrier pattern that is the most suitable to reproduce the encoded stereoscopic image data. As described above, the barrier pattern is disposed on a barrier polarizing plate in the shape of a vertical or horizontal line. The minute linear shape may have an effect on image quality of a three-dimensional image. In addition, information on an interval of the barrier pattern based on a position on the display device (information on whether the interval is constant regardless of the position or whether the interval depends on the position) may have an effect on image quality of a three-dimensional image.

FIGS. 8 and 9 are block diagrams illustrating a file format for storing encoded stereoscopic image data according to an embodiment of the present invention. FIG. 9 is a block diagram illustrating a structure of a stereoscopic track container 210 of FIG. 8. In addition, FIG. 10 illustrates a hierarchical structure of the file format shown in FIGS. 8 and 9. As is known with reference to FIGS. 8 to 10, the file format according to the embodiment of the present invention is based on an ISO base media file format.

Firstly referring to FIGS. 8 and 10, the file format according to the embodiment of the present invention mainly includes a file type declaration unit (ftyp) 100, a meta data unit (moov) 200, and an image data unit (mdat) 300.

The file type declaration unit 100 is used to represent that a corresponding file is used for a stereoscopic image. In a case where the file is used for the stereoscopic image, the file type declaration unit 100 may include information on the number of ESs which constitute the stereoscopic image. As shown in FIGS. 8 and 10, the file type declaration unit 100 that is a sub-classifier of an ftyp container includes a box for including information for indicating whether a file has a stereoscopic type and/or information on the number of ESs which constitute the stereoscopic image. This box may be a stereoscopic type box (ssty) 110 as shown in FIGS. 8 and 10. Then, a decoder of the stereoscopic image can recognize whether the file is related to the stereoscopic image and/or recognize the number of ESs which constitute the stereoscopic image. These are summarized as follows.

ssty (Stereoscopic Type)

Box Type: ‘ssty’

Container: File Type Box (‘ftyp’)

Mandatory: Yes

Quantity: Exactly one

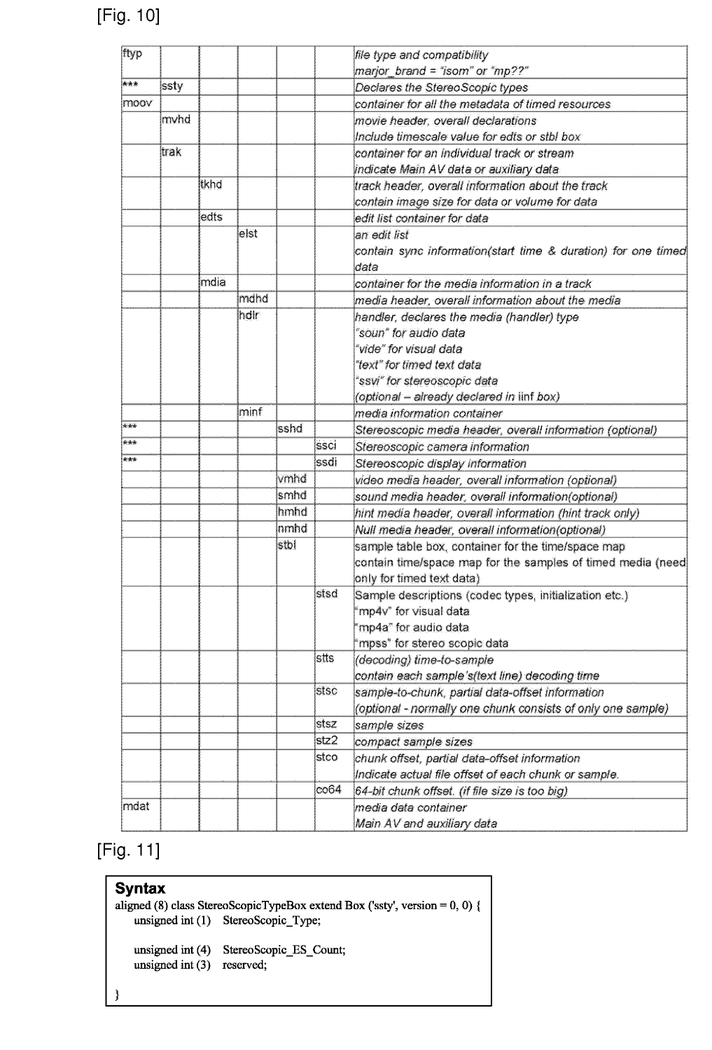

As is known through the aforementioned description, in case of the encoded stereoscopic image data, the ssty box 110 is an essential component. Only one ssty box exists in the ftyp container. FIG. 11 illustrates an example of a syntax of the ssty box 110. In FIG. 11, an element of ‘Stereoscopic_Type’ indicates whether a file is a stereoscopic file. For example, the value of the element may be allocated like Table 1. In addition, an element of ‘StereoScopic_ES_Count’ indicates the number of ESs which constitute the stereoscopic file.

TABLE 1

| Value | Contents |
|---|---|
| 0 | A file is not a stereoscopic data file. |
| 1 | A file is a stereoscopic data file. |

Referring to FIGS. 8 and 10, a moov container that is the meta data unit 200 includes one or more track containers 210 or 220 for storing meta data of the file. In a case where the file is a stereoscopic image file, the moov container includes stereoscopic track containers 210 in correspondence with the number of ESs which constitute the file, for example, a stereoscopic track container track1(stereoscopic) for an elementary stream ES1, a stereoscopic track container track2(stereoscopic) for an elementary stream ES2, . . . , and a stereoscopic track container track(n)(stereoscopic)(here, n is an integer equal to or greater than one). On the other hand, in a case where the file is not a stereoscopic image file, the moov container includes a non-stereoscopic track container 220, for example, a track container track(non-stereoscopic) for a monoscopic image and meta data of an audio or text file. Since the present invention relates to a stereoscopic image, hereinafter, a structure of the stereoscopic track container 210 will be described with reference to FIGS. 9 and 10.

The stereoscopic track container 210 includes a media container (media) 211. The media container 211 is defined so as to include information on a media stream stored in a container that is referred to as a track. The media container 211 includes a handler reference box (hdlr) 212 and a media information container (minf) (not shown). The media information container (mint) may be a box for including information on a size of an image to be represented by an ES (this box may be a stereoscopic header box (sshd) 213, and the name thereof may be changeable) and a sample table box (stbl) 216.

The handler reference box 212 includes information on definition of a stream type of the ES. In a case where the ES is data obtained by encoding a stereoscopic image, a value of information included in the handler reference box 212 may be represented as ‘ssvi’, for example. The handler reference box 212 is represented as follows.

hdlr (Handler Reference)

Box Type: ‘hdlr’

Container: Media Box (‘media’)

Mandatory: Yes

Quantity: Exactly one

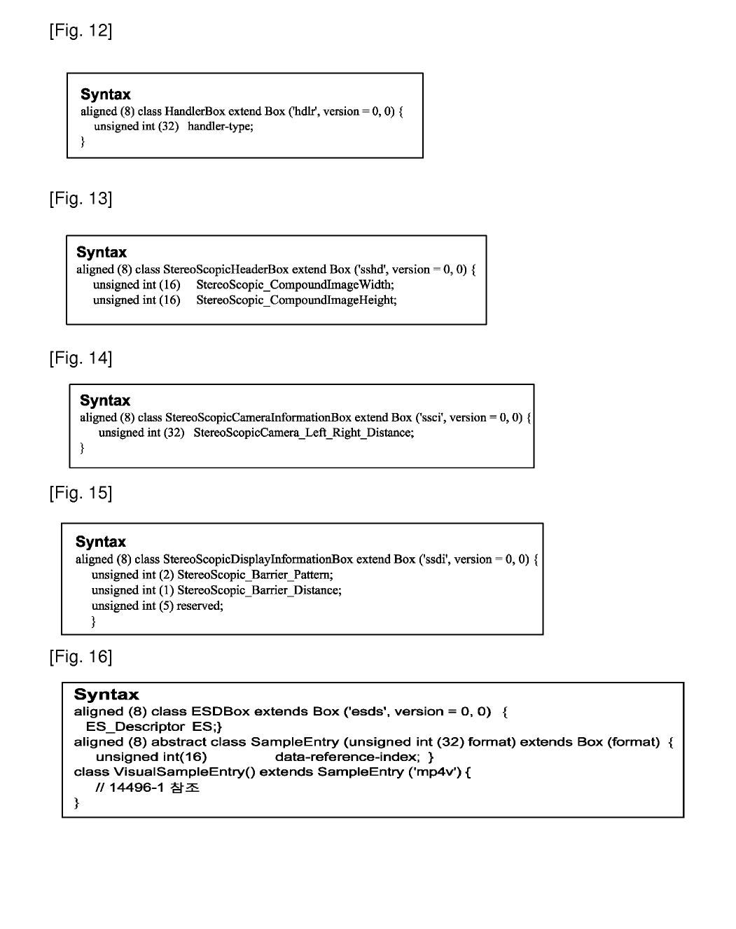

As is known through the aforementioned description, the hdlr box 212 is an essential component. Only one handler reference box 212 exists in the media container 211. FIG. 12 illustrates an example of a syntax of the hdlr box 211. In FIG. 12, an element of ‘handler_type’ is used to define a stream type of media data. Table 2 shows an example of a stream type in which definition of an existing stream includes definition of a stereoscopic image stream of the present invention.

TABLE 2

| Value | Contents |
|---|---|
| ssvi | Stereoscopic visual data |
| soun | Audio data |
| vide | Visual data |
| text | Text data |
| hint | Hint data |

The stereoscopic header box 213 includes information on a size of an image to be represented by an ES. For example, the stereoscopic header box 213 may include information on a width and/or a height of a stereoscopic composite image represented by the ES. FIG. 13 illustrates an example of a syntax of the stereoscopic header box 213. In FIG. 13, an element of ‘StereoScopic_CompoundImageWidth’ indicates a width of a stereoscopic composite image, and an element of ‘StereoScopic_CompoundImageHeighe indicates a height of a stereoscopic composite image. This stereoscopic header box 213 is represented as follows.

sshd (StereoScopic Header)

Box Type: ‘sshd’, ‘vmhd’, ‘smhd’, ‘hmhd'

Container: Medialnformation Box (‘minf’)

Mandatory: Yes (must be present)

Quantity: Exactly one

As is known through the aforementioned description, the sshd box 213 is an essential component. Only one stereoscopic header box 213 exists in the minf container (not shown). The minf container may further include a header box for another type of media in addition to the sshd box 213. Table 3 shows an example of a value of a header box to be included in the minf container.

TABLE 3

| value | Contents |
|---|---|
| sshd | Stereoscopic visual media header |
| smhd | Audio media header |
| vmhd | Visual media header |
| hmhd | Hint media header |
| nmhd | Null media header |

Referring to FIGS. 9 and 10, the stereoscopic header box 213 further includes a box for including information on left and right cameras used to obtain a stereoscopic image and a box for including information on a display device used to display the stereoscopic image. The boxes may be a stereoscopic camera information box (ssci) 214 and a stereoscopic display information box (ssdi) 215. Names of the boxes may be changeable.

The stereoscopic camera information box (ssci) 214 may include information on the left and right cameras, for example, information on a distance between the left and right cameras. The stereoscopic camera information box 214 is summarized as follows.

ssci (StereoScopic Camera Information)

Box Type: ‘ssci’

Container: Stereoscopic Header Box (‘sshd’)

Mandatory: No

Quantity: Zero or One

As is known through the above summary, the ssci box 214 is an optional component. In a case where the ssci box 214 is included in the stereoscopic header box 213, only one sshd box 214 exists in the sshd box 213 that is a container. FIG. 14 illustrates an example of a syntax of the ssci box 214. In FIG. 14, an element of ‘Stereo-ScopicCamera_Left_Right-Distance’ indicates a distance between left and right cameras.

The stereoscopic display information box 215 may include information on a display device, for example, information on a type of a barrier pattern and/or information on an interval of the barrier pattern. The stereoscopic display information box 215 is summarized as follows.

ssdi (StereoScopic Display Information)

Box Type: ‘ssdi’

Container: Stereoscopic Header Box (‘sshd’)

Mandatory: No

Quantity: Zero or One

As is known through the above summary, the ssdi box 215 is an optional component.

In a case where the ssdi box 215 is included in the sshd box 213, only one ssdi box 215 exists in the sshd box 213 that is the container. FIG. 15 illustrates an example of a syntax of the ssdi box 215. In FIG. 15, an element of ‘StereoScopic_Barrier_Pattern’ indicates a type of a barrier pattern. For example, the value of the type may be allocated like Table 4. In addition, an element of ‘StereoScopic_Barrier_Distance’ indicates an interval of the barrier pattern. When the value of the interval is 0, it represents a non-fixed rate. When the value of the interval is 1, it represents a fixed rate. Here, the fixed rate represents that the interval of the barrier pattern is constant regardless of a position on the display device. The non-fixed rate represents that the interval of the barrier pattern depends on a position on the display device (for example, center and edge parts).

TABLE 4

| Value | Contents |
|---|---|
| 00 | Bar type |
| 01 | Saw-tooth type |
| 10 | Oblique line type |

Referring to FIGS. 9 and 10, the sample table box 216 that is a container for a time/space map includes a sample description box (stsd) 217. The sample description box 217 that is used to define description of a media stream (ES) defined in the track container 210 includes a box for indicating a stereoscopic visual sample entry. This box may be referred to as an mpss box 218. This box is not limited thereto. The sample description box 217 may further include an mp4v box for indicating a visual sample entry, an mp4a box for indicating an audio sample entry, and the like, in addition to the mpss box 218.

The mpss box 218 is a box container for disclosing detailed information on ESs which constitute encoded stereoscopic image data. The mpss box 218 is summarized as follows.

mpss (StereoScopic Visual Sample Entry)

Box Type: ‘mpss’, ‘mp4v’, ‘mp4a’

Container: Stereoscopic Table Box (‘stbl’)

Mandatory: Yes

Quantity: Exactly One

As is known through the above summary, the mpss box 218 is an essential component. Only one mpss box 218 exists in the stbl container 217. The stbl container 217 may further include a sample entry of another type of media in addition the mpss box 218. Table 5 shows an example of a sample entry to be included in the stbl container 217.

TABLE 5

| Value | Contents |
|---|---|
| mpss | Stereoscopic visual sample entry |
| mp4v | Visual sample entry |
| mp4a | Audio sample entry |

The mpss box 218 includes information on a method of constructing a frame to be encoded, various types of derivative information, and the like. The information included in the mpss box 218 may be changed according to the number of ESs which constitute the encoded stereoscopic image data and/or a type of a frame to be encoded corresponding to an ES. More specifically, the mpss box 218 may include information on a type of a frame to be encoded (a construction method), information on frame rates of left and right images, a size of an image that constructs the frame to be encoded, the number of lines of fields which construct the frame to be encoded, and/or disparity information of the left and right images which construct the frame to be encoded. Hereinafter, contents of information to be included in the mpss box 218 will be described in detail based on the number of ESs of the encoded stereoscopic image data.

First, a case where there is an ES will be described. In case of one ES, the method of constructing a frame to be encoded may be one of the methods illustrated in FIGS. 2 to 4. There are five methods of constructing a frame to be encoded, which are shown in FIGS. 2 to 4. The information included in the mpss box 218 has to support the above five types. Accordingly, the mpss box 218 includes information for indicating a type of a frame to be encoded which constitutes the ES. The type of the frame is represented as ‘StereoScopic_CompositionType’. The value of the type may be allocated by using three bits like Table 6. Table 6 shows an example.

TABLE 6

| Value | Contents |
|---|---|
| 000 | Left and right images are alternately arranged |
| | in units of frame in the direction of time |
| | axis (refer to FIG. 4) |
| 001 | Left and right images are arranged side by |
| | side (left side of FIG. 2) |
| 010 | Left and right images are arranged in a top- |
| | down manner (right side of FIG. 2) |
| 011 | Vertical pixel lines of left and right images |
| | are alternately arranged (left side of FIG. 3) |
| 100 | Horizontal pixel lines of left and right |
| | images are alternately arranged (right side of |
| | FIG. 3) |

In a case where a frame to be encoded is the frame 22, 24, 32, or 34 shown in FIGS. 2 and 3, the mpss box 218 may further include information on a size of the frame to be encoded. For example, in a case where a frame to be encoded is the frame shown in the left side of FIG. 2, the mpss box 218 may include information on a width of an image. In a case where a frame to be encoded is the frame shown in the right side of FIG. 2, the mpss box 218 may include information on a height of the image. In a case where a frame to be encoded is the frame shown in the left side of FIG. 3, the mpss box 218 may include information on a width of an interleaved vertical line in units of field. In a case where a frame to be encoded is the frame shown in the right side of FIG. 3, the mpss box 218 may include information on a width of an interleaved horizontal line in units of field.

The information on a frame to be encoded may be represented as ‘width_or_height’. For example, in a case where a value of Stereoscopic_CompositionType disclosed in Table 6 is ob001, the value of ‘width_or_height’ may indicate a width of an image. In a case where a value of Stereoscopic_CompositionType is 0b010, the value of ‘width_or_height’ may indicate a height of an interleaved vertical line in units of field. In a case where a value of Stereoscopic_CompositionType is 0b100, the value of ‘width_or_height’ may indicate a height of an interleaved horizontal line in units of field.

In addition, in a case where a frame to be encoded is the frame 22, 24, 32, or 34 shown in FIGS. 2 and 3, the mpss box 218 may include information on the number of lines which constitute odd and even line fields that are component images of the frame to be encoded. For example, in a case where the frame is the frame 22 or 24 shown in FIG. 2, the number of field lines is zero. In a case where the frame is the frame 32 or 34, the mpss box 218 may include information on the number of lines which constitute an odd line field and/or the number of lines which constitute an even line field.

Information on the number of lines which constitute the odd line fields may be represented by ‘odd_field_count’. Information on the number of lines which constitute an even line field may be represented by ‘even_field_count’. For example, in a case where a value of StereoScopic_CompositionType disclosed in Table 6 is 0b001 or 0b010, the values of ‘odd_field_count’ and ‘even_field_count’ are 0's. In a case where a value of StereoScopic_CompositionType is 0b011 or 0b100, the values of ‘odd_field_count’ and ‘even_field_count’ may represent the number of odd lines and the number of even lines, respectively.

The mpss box 218 may further include information on whether a frame rate of the odd line field is the same as that of the even line field and information on a synchronization method in a case where the frame rates of the odd and even line fields are different. Here, in a case where frame rates of two images are different from each other, the information on the synchronization method may be information on a reference image for matching the frame rates with each other when displaying the stereoscopic image. That is, the information on the synchronization method may be information on the reference image. The information on the frame rate and/or the synchronization method may be represented as ‘StereoScopic_ES_FrameSync’ and allocated as shown in Table 7 by using two bits. Table 7 indicates an example in a case where there is one ES.

TABLE 7

| Value | Contents |
|---|---|
| 00 | A frame rate of a left image (odd line field) |
| | is the same as that of a right image (even |
| | line field) |
| 01 | A frame rate of a left image is different from |
| | that of a right image, and the left image (or |
| | odd line field) is a reference image |
| 10 | A frame rate of a left image is different that |
| | of a right image, and the right image (or even |
| | line field) is a reference image |

The mpss box 218 may further include information on existence of disparity, that is, a difference in image information between odd line and even line fields (for example, Y/Cb/Cr value or R/G/B value) and a disparity value in a case where there is disparity (information on disparity). Here, the disparity value indicates information on a difference value of an image (or field) with respect to another image (or field). The disparity information is used to modify three-dimensional effects of a displayed stereoscopic image.

Information on existence of disparity included in the disparity information is represented as ‘StereoScopic_ImageInformationDifference’ and allocated as shown in Table 8 by using two bits. Table 8 indicates an example in a case where there is one ES.

TABLE 8

| Value | Contents |
|---|---|
| 00 | Disparity between left and right images (odd |
| | line and even line fields) is zero |
| 01 | Disparity is not zero, and a left image (or |
| | odd line field) is a reference image |
| 10 | Disparity is not zero, and a right image (or |
| | even line field) is a reference image |

A disparity value included in the disparity information may be represented as a difference in image information. There are various methods of representing image information. Typical method is a Y/Cb/Cr or R/G/B method. Accordingly, the disparity value may be represented by using the method as follows.

Y_or_R_difference: a difference in image information of a Y or R vaue

Cb_or_G_difference: a difference in image information of a Cb or G value

Cr_or_B_difference: a difference in image information of a Cr value or B value

Next, a case where there are two ESs will be described. In case of two ESs, the method of constructing a frame to be encoded may be one of the methods illustrated in FIG. 5 or 6, for example. In case of two ESs, the moov container 200 includes two track containers which are track1 and track2 containers. Then, each track container may include meta data information of a corresponding ES. Hereinafter, a difference between a case where there is one ES and a case where there are two ESs will be described.

In a case where there are two ESs of encoded stereoscopic image data, the mpss box 218 includes information on a type of a frame to be encoded which constructs a corresponding ES. Referring to FIGS. 5 and 6, since types of the frame to be encoded may include a left image, a right image, a reference image, and a differential image, the mpss box 218 includes information on the types of the frame. A type of the frame to be encoded is represented as ‘StereoScopic ES Type’. The value of the type may be allocated by using two bits like Table 9. Table 9 shows an example.

TABLE 9

| Value | Contents |
|---|---|
| 00 | Left image |
| 01 | Right image |
| 10 | Reference image |
| 11 | Differential image |

The mpss box 218 may further include information on whether a frame rate of the left image is the same as that of the right image and information on a synchronization method in a case where the frame rates of the left and right images are different from each other. Only in a case where a frame to be encoded is the frame shown in FIG. 5 (a frame constructed with left and right images), the mpss box 218 includes the information on a frame rate. In a case where a frame to be encoded is the frame shown in FIG. 6, the mpss box 218 does not include the information on a frame rate. The information on the frame rate and/or the synchronization method may be represented as ‘StereoScopic_ES_FrameSync’ and allocated as shown in Table 10 by using two bits. Here, Table 10 indicates an example in a case where there are two ESs.

TABLE 10

| Value | Contents |
|---|---|
| 00 | A frame rate of a left image is the same as |
| | that of a right image, or information on the |
| | frame rate is unnecessary |
| 01 | A frame rate of a left image is different from |
| | that of a right image, and a frame of a |
| | corresponding ES is a reference image |
| 10 | A frame rate of a left image is different from |
| | that of a right image, and a frame of a counter |
| | part of the corresponding ES is a reference |
| | image |

The mpss box 218 may further include information on existence of disparity, that is, a difference in image information between left and right images (for example, Y/Cb/Cr value or R/G/B value) and a disparity value in a case where there is disparity (information on disparity). Only in a case where a frame to be encoded is a frame shown in FIG. 5 (a frame constructed with left and right images), the mpss box 218 includes the disparity information. In a case where a frame to be encoded is the frame shown in FIG. 6, the mpss box 218 does not include the disparity information. The disparity information may be represented as ‘StereoScopic_ImageInformationDifference’ and allocated as shown in Table 11 by using two bits. Here, Table 10 indicates an example in a case where there are two ESs.

TABLE 11

| Value | Contents |
|---|---|
| 00 | Disparity between left and right images is zero |
| | or is not considered |
| 01 | Disparity is not zero, and a frame of a |
| | corresponding ES is a reference image |
| 10 | Disparity is not zero, and a frame of a |
| | counterpart of a corresponding ES is a |
| | reference image |

The disparity value that is a difference in image information may not be included in the mpss box 218 of the corresponding ES but included in an mpss box of another ES that is a counterpart of the corresponding ES. In this case, information on existence of the disparity and information on a disparity value may be distributed over the two ESs.

In a case where the stereoscopic ES type for representing a type of a frame to be encoded corresponds to the image shown in FIG. 6, the frame to be encoded is divided into a reference image and a differential image. Accordingly, in a case where ‘StereoScopic_ES_Type’ indicates a reference image or a differential image, the frame rate information and the disparity information is not necessary for the ES. Thus, in a case where the frame to be encoded is the image shown in FIG. 6 as a case of two ESs, the mpss box 218 does not include this information.

Next, a case where there are three or more ESs will be described. In case of three or more ESs, a frame to be encoded is shown in FIG. 7. The frame of FIG. 7 is the same as that of FIG. 6 in that the frame is constructed with a reference image and a differential image. Accordingly, in case of three or more ESs, the information included in the mpss box 218 is the same as that of a case where a type of a frame to be encoded is the image shown in FIG. 6 as a case of two ESs. Thus, description on the information will be omitted.

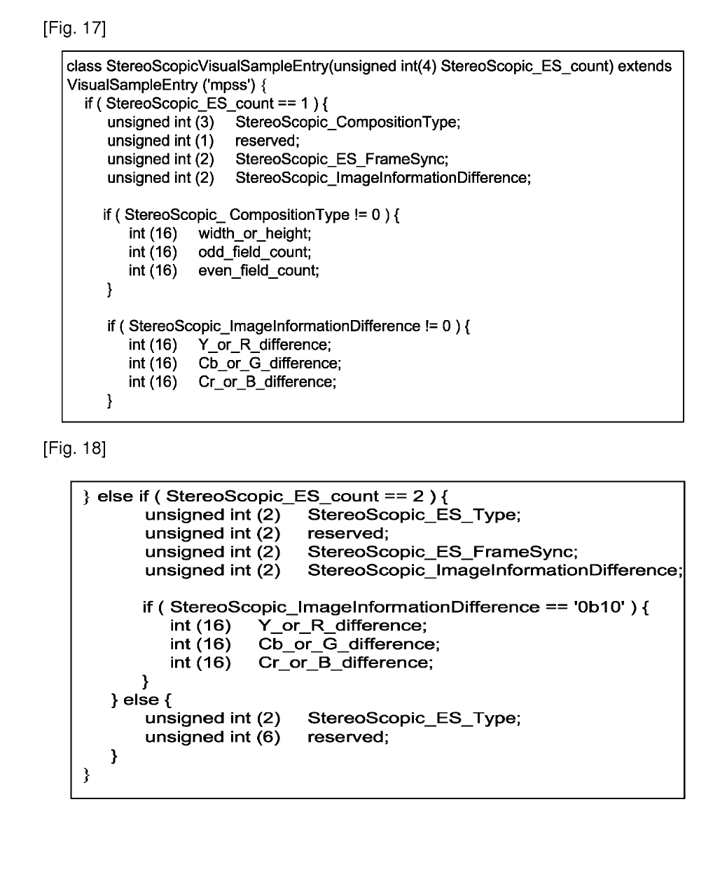

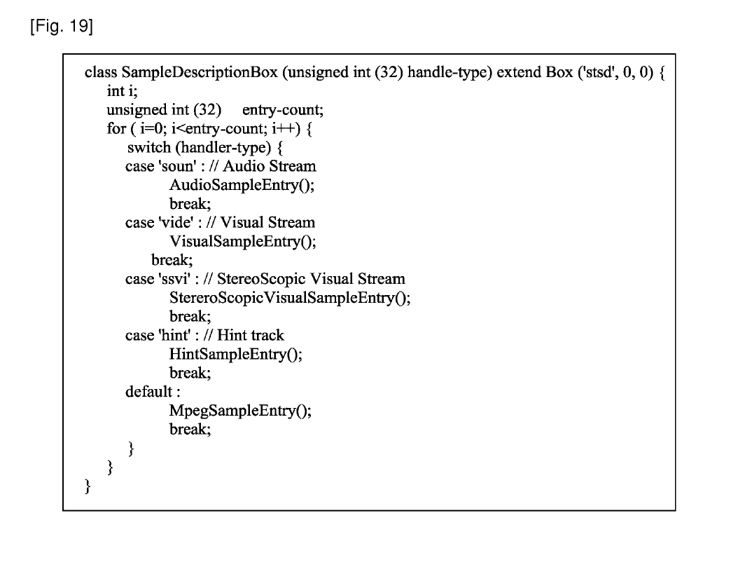

Examples of syntaxes about the mpss box 218 including the aforementioned information are shown in FIGS. 16 to 19. Although the syntaxes shown in FIGS. 16 to 19 have to be represented as one syntax originally, the syntaxes are separated due to the limit of the space of this paper. Accordingly, a syntax shown in FIG. 16, is sequentially connected to a syntax shown in FIG. 17. Subsequently, syntaxes of FIGS. 18 and 19 follow the syntax of FIG. 17. Since the syntaxes have been described in detail, description on the syntaxes will be omitted.

Continuously, referring to FIG. 8, an mdat container that is the image data unit (mdat) 300 includes encoded image information of a frame to be encoded. The mdat container includes one or more stereoscopic image data containers (Stereoscopic Image Data) 310. Each stereoscopic image data container 310 corresponds to each track container (track) 210 included in the meta data unit 200. Accordingly, the image data unit 300 includes stereoscopic image data containers 310 in correspondence with the number of ESs. Since types of image data included in each stereoscopic image data container 310 are similar to those of existing image data, hereinafter detailed description on the types of image data will be omitted.

While the present invention has been particularly shown and described with reference to exemplary embodiments thereof, it will be understood by those skilled in the art that various changes in form and details may be made therein without departing from the spirit and scope of the present invention as defined by the appended claims.

### INDUSTRIAL APPLICABILITY

The present invention relates to stereoscopic image codec.

1. A method of constructing a file of encoded stereoscopic image data, wherein the file comprises:
a file type declaration unit indicating whether the file is a stereoscopic image;
a meta data unit including one or more track containers for containing meta data of the encoded stereoscopic image data; and
an image data unit including one or more stereoscopic image data containers for containing image information of the encoded stereoscopic image data.

2. The method of claim 1, wherein the file type declaration unit includes first information for indicating whether the file is related to a stereoscopic image and second information for indicating the number of elementary streams (ESs) which constitute the file.

3. The method of claim 2, wherein the number of the track containers and the number of the stereoscopic image data containers are the same as the second information.

4. The method of claim 2, wherein the track container includes:
a handler reference container for indicating a type of a corresponding ES; and
a media information container for containing meta data of the corresponding ES.

5. The method of claim 4, wherein the media information container includes a stereoscopic header container containing information for indicating a size of a frame to be encoded.

6. The method of claim 5, wherein the stereoscopic header container includes a container for containing information for indicating a distance between left and right cameras used to obtain the stereoscopic image.

7. The method of claim 5, wherein the stereoscopic header container includes a container for containing information for indicating a distance of a barrier pattern of a barrier type display device used to display the stereoscopic image and/or information for indicating an interval of the barrier pattern.

8. The method of claim 4, wherein the media information container includes a sample description container for defining description of the corresponding ES.

9. The method of claim 8, wherein the sample description container includes ES type information for indicating a method of constructing a frame to be encoded.

10. The method of claim 9,
wherein the second information of the file type declaration unit indicates that the number of ESs is one,
wherein the frame to be encoded which is indicated by the ES type information has one of first to fifth types,
wherein in the first type, the left and right images are alternately arranged in units of frame in the direction of time axis,
wherein in the second type, the left and right images are arranged side by side,
wherein in the third type, the left and right images are arranged in a top-down manner,
wherein in the fourth type, vertical pixel lines of the left and right images are alternately arranged, and
wherein in the fifth type, horizontal pixel lines of the left and right images are alternately arranged.

11. The method of claim 10,
wherein the ES type information indicates one of the second to fifth types, and
wherein the sample description container further includes information on frame rates of the left and right images which constitute the frame to be encoded and/or disparity information.

12. The method of claim 11, wherein the information on the frame rate includes information on whether a frame rate of the left image is the same as that of the right image and information for matching the frame rates of the left and right images with each other when displaying the stereoscopic image in a case where the frame rates of the left and right images are different from each other.

13. The method of claim 11, wherein the disparity information includes information on whether there is disparity between the left and right images and information for modifying the disparity in a case where there is disparity between the left and right images.

14. The method of claim 9,
wherein the second information of the file type declaration unit indicates that the number of ESs is two, and
wherein the frame to be encoded which is indicated by the ES type information is one of a left image, a right image, a reference image, and a differential image.
